(19) United States
(12) Patent Application Publication
(10) Pub. No.: US 2026/0332815 A1
(43) Pub. Date: Oct. 22, 2026

(54) METHOD AND APPARATUS FOR VIDEO CODING USING SUB-BLOCK PARTITIONING-BASED COMBINED INTER AND INTRA PREDICTION

(71) Applicants: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(72) Inventors: Dong Gyu SIM, Seoul (KR); Joo Hyung BYEON, Seoul (KR); Min Hun LEE, Uijeongbu-si, Gyeonggi-do (KR); Jin HEO, Yongin-si, Gyeonggi-do (KR); Jung Ah CHOI, Seoul (KR); Seung Wook PARK, Yongin-si, Gyeonggi-do (KR)

(73) Assignees: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(21) Appl. No.: 19/475,876

(22) PCT Filed: Mar. 5, 2024
(86) PCT No.: PCT/KR2024/002799

§ 371 Date: Oct. 16, 2025

(30) Foreign Application Priority Data
May 10, 2023 (KR) 10-2023-0060321
Mar. 4, 2024 (KR) 10-2024-0030640

(51) Int. Cl. H04N 19/593; H04N 19/105; H04N 19/11; H04N 19/119; H04N 19/139; H04N 19/176; H04N 19/513

(52) U.S. Cl. CPC H04N 19/593; H04N 19/105; H04N 19/11; H04N 19/119; H04N 19/139; H04N 19/176; H04N 19/513

(57) ABSTRACT

A method and an apparatus are disclosed for video coding using subblock partitioning-based combined inter and intra prediction. In the disclosed embodiments, the video decoding device generates an inter-prediction block of the current block. The video decoding device derives an intra-prediction mode of the current block, determines whether the current block is to be subblock-partitioned and a partition shape based on a size of the current block and the intra-prediction mode, and generates an intra-prediction block of the current block based on the whether the current block is to be subblock-partitioned, and the intra-prediction mode. The video decoding device determines weights for the inter-prediction block and the intra-prediction block based on one or more of a number of blocks decoded according to intra prediction among neighboring blocks of the current block, a number of blocks decoded according to inter prediction among the neighboring blocks, the intra-prediction mode, the size of the current block, and the whether the current block is to be subblock-partitioned; and generates a final prediction block of the current block by weighted summing the inter-prediction block and the intra-prediction block based on the weights.

### TECHNICAL FIELD

The present disclosure relates to a video coding method and an apparatus using subblock partitioning-based combined inter and intra prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In VVC, the combined inter and intra prediction (CIIP) technique weighted sums an inter-prediction block and an intra-prediction block to generate a prediction block of the current block. The CIIP technique determines weights based on whether the left block and top block adjacent to the current block are inter-predicted or intra-predicted. CIIP technique uses planar mode for an intra-prediction mode and a regular merge mode for an inter-prediction mode.

In beyond VVC, i.e., enhanced compression model (ECM), CIIP technique uses the template-based intra mode derivation (TIMD) process to determine a prediction mode with the smallest sum of absolute transformed differences (SATD) value between neighboring reconstructed reference samples (i.e., template) and a prediction block of the template as an intra-prediction mode of the current block. After partitioning the current block into subblocks, the CIIP technique determines the weights of the respective subblocks based on the directionality of the intra-prediction mode.

Therefore, to increase video coding efficiency and enhance video quality, when applying the combined inter and intra prediction to the current block, there is a need for a method of effectively performing subblock partitioning of the current block and prediction of each subblock.

### DISCLOSURE

### Technical Problem

The present disclosure seeks to provide a video coding method and an apparatus that, when combined inter and intra prediction is applied to the current block, use as a basis the intra-prediction mode and inter-prediction mode of the current block for partitioning the current block into subblocks and predict each subblock.

### Technical Solution

At least one aspect of the present disclosure provides a method of reconstructing a current block by a video decoding apparatus. The method includes generating a motion vector of the current block and generating an inter-prediction block of the current block based on the motion vector. The method also includes deriving an intra-prediction mode of the current block, and determining whether the current block is to be subblock-partitioned and a partition shape based on a size of the current block and the intra-prediction mode. The method also includes generating an intra-prediction block of the current block based on the whether the current block is to be subblock-partitioned, and the intra-prediction mode. The method also includes determining weights for the inter-prediction block and the intra-prediction block based on one or more of a number of blocks decoded according to intra prediction among neighboring blocks of the current block, a number of blocks decoded according to inter prediction among the neighboring blocks, the intra-prediction mode, the size of the current block, and the whether the current block is to be subblock-partitioned. The method also includes generating a final prediction block of the current block by weighted summing the inter-prediction block and the intra-prediction block based on the weights.

Another aspect of the present disclosure provides a method of encoding a current block by a video encoding apparatus. The method includes determining a motion vector of the current block and generating an inter-prediction block of the current block based on the motion vector. The method also includes deriving an intra-prediction mode of the current block, and determining whether the current block is to be subblock-partitioned and a partition shape based on a size of the current block and the intra-prediction mode. The method also includes generating an intra-prediction block of the current block based on the whether the current block is to be subblock-partitioned, and the intra-prediction mode. The method also includes determining weights for the inter-prediction block and the intra-prediction block based on one or more of a number of blocks decoded according to intra prediction among neighboring blocks of the current block, a number of blocks decoded according to inter prediction among the neighboring blocks, the intra-prediction mode, the size of the current block, and the whether the current block is to be subblock-partitioned. The method also includes generating a final prediction block of the current block by weighted summing the inter-prediction block and the intra-prediction block based on the weights.

Yet another aspect of the present disclosure provides a computer-readable recording medium storing a bitstream generated by a video encoding method. The video encoding method includes determining a motion vector of a current block and generating an inter-prediction block of the current block based on the motion vector. The video encoding method also includes deriving an intra-prediction mode of the current block, and determining whether the current block is to be subblock-partitioned and a partition shape based on a size of the current block and the intra-prediction mode. The video encoding method also includes generating an intra-prediction block of the current block based on the whether the current block is to be subblock-partitioned, and the intra-prediction mode. The video encoding method also includes determining weights for the inter-prediction block and the intra-prediction block based on one or more of a number of blocks decoded according to intra prediction among neighboring blocks of the current block, a number of blocks decoded according to inter prediction among the neighboring blocks, the intra-prediction mode, the size of the current block, and the whether the current block is to be subblock-partitioned. The video encoding method also includes generating a final prediction block of the current block by weighted summing the inter-prediction block and the intra-prediction block based on the weights.

### Advantageous Effects

As described above, the present disclosure provides a video coding method and an apparatus that, when the combined inter and intra prediction is applied to the current block, use as a basis the intra-prediction mode and inter-prediction mode of the current block for partitioning the current block into subblocks and predict each subblock. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating neighboring blocks used to determine weights in combined inter and intra prediction (CIIP).

FIG. 7 is a diagram illustrating the subblock sequence for applying weights in the present disclosure.

FIGS. 8A and 8B are diagrams illustrating the subblock partitioning of the current block.

FIG. 9 is a block diagram illustrating a detailed portion of a video decoding apparatus according to at least one embodiment of the present disclosure.

FIG. 10 is a diagram illustrating the determination of the merge mode according to at least one embodiment of the present disclosure.

FIG. 11 is a diagram illustrating an organization of merge candidates based on template matching, according to at least one embodiment of the present disclosure.

FIG. 12 is a diagram illustrating partition shapes of the current block, according to at least one embodiment of the present disclosure.

FIG. 13 is a diagram illustrating sub-areas partitioned from the current block, according to at least one embodiment of the present disclosure.

FIG. 14 is a diagram illustrating sub-areas partitioned from the current block, according to another embodiment of the present disclosure.

FIG. 15 is a flowchart of a method of encoding a current block by a video encoding apparatus, according to at least one embodiment of the present disclosure.

FIG. 16 is a flowchart of a method of reconstructing a current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

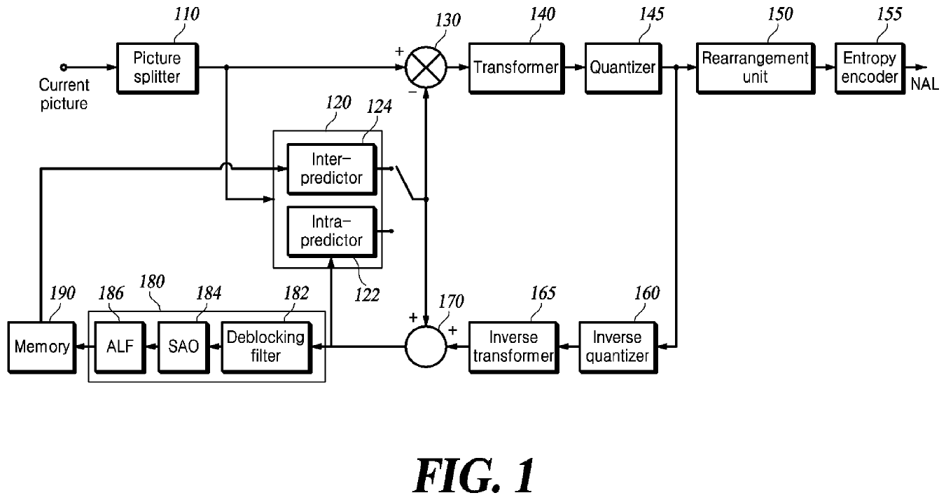

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU).

Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

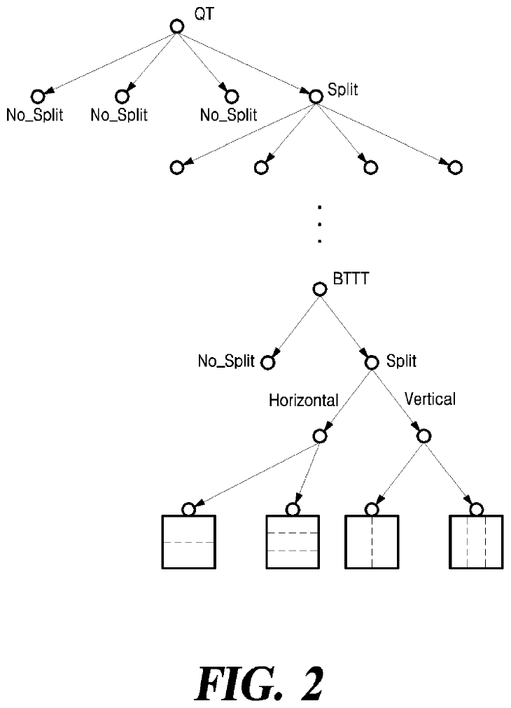

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape. The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

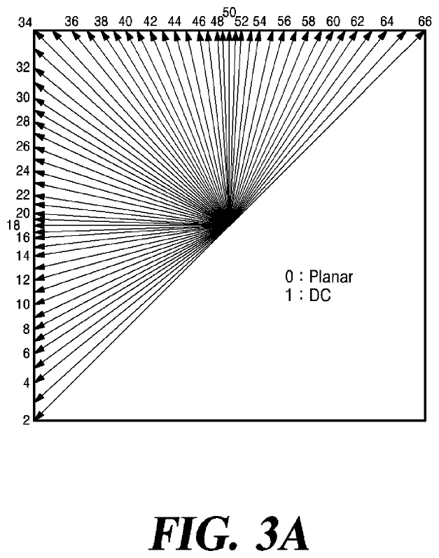

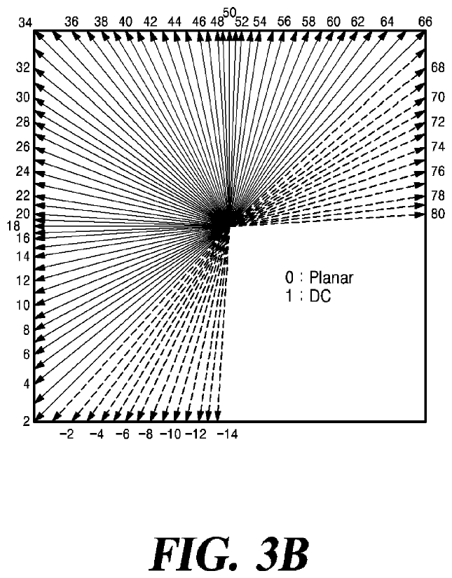

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

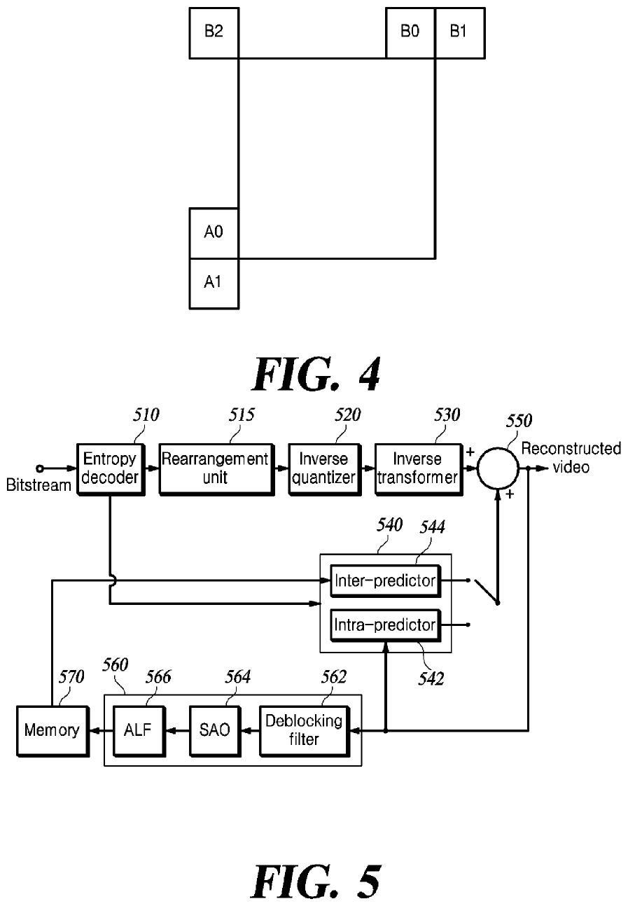

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a ID coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and

extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that, when a combined inter and intra prediction is applied to the current block, use as a basis the intra-prediction mode and inter-prediction mode of the current block for partitioning the current block into subblocks and predict each subblock.

The following embodiments may be performed by the predictor 120 in the video encoding device. The following embodiments may also be performed by the predictor 540 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. COMBINED INTER AND INTRA PREDICTION (CIIP)

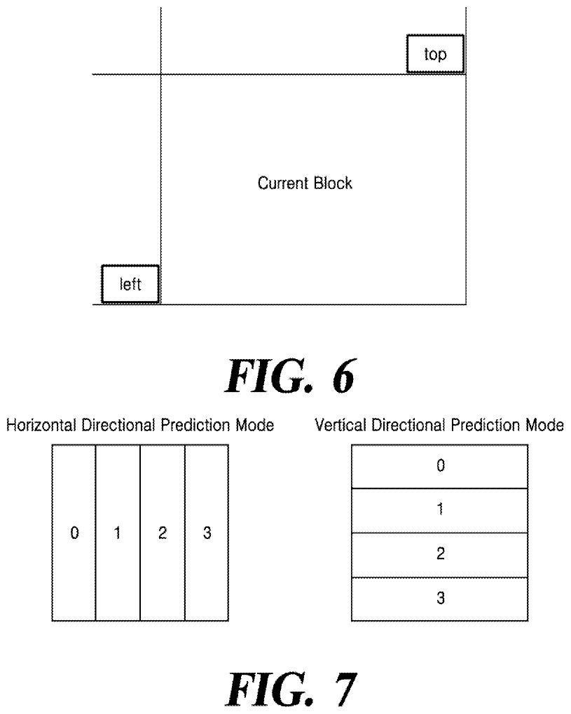

In versatile video coding (VVC), the combined inter and intra prediction (CIIP) technique weighted sums an inter-prediction block Pᵢₙₜₑᵣ and an intra-prediction block Pᵢₙₜᵣₐ to generate a prediction block of the current block. The CIIP technique determines weights based on whether an adjacent left block and an adjacent top block to the current block are inter- or intra-predicted, as illustrated in FIG. 6. The prediction block P_{CIIP} is determined according to the determined weight w, as shown in Equation 1.

P_{CIIP}=((4−w)×Pᵢₙₜᵣₐ+w×Pᵢₙₜₑᵣ)>>2 [Equation 1]

In the example of FIG. 6, when both the left block and the top block are intra-predicted, w is determined to be 1, and when both the left block and the top block are inter-predicted, w is determined to be 3. When one of the left block and top block is intra-predicted and the other is inter-predicted, w is determined to be 2. The determined weight w is applied to entire prediction block. Meanwhile, the CIIP technique uses the planar mode for the intra-prediction mode and uses the regular merge mode for the inter-prediction mode.

In beyond versatile video coding (VVC), i.e., enhanced compression model (ECM), the CIIP technique performs the template-based intra mode derivation (TIMD) process based on the intra-prediction modes shown in FIG. 3A. The prediction mode that causes the smallest sum of absolute transformed differences (SATD) value between the neighboring reconstructed reference samples (i.e., template) and the template's prediction block is derived for the intra-prediction mode of the current block. The TIMD process uses the template's neighboring reference samples to generate the template's prediction block. After partitioning the current block into subblocks, the CIIP technique determines the weight of each subblock based on the directionality of the intra-prediction mode. When the derived intra-prediction mode is a directional mode, the subblock sequence is determined as shown in FIG. 7, depending on whether the directionality is closer to the vertical direction or the horizontal direction. In the example in FIG. 7, the prediction mode closer to the horizontal direction is when 2≤Modeᵢₙₜᵣₐ<34 according to the example in FIG. 3A, and the prediction mode closer to the vertical direction is when 34≤Modeᵢₙₜᵣₐ≤66. Upon determining the weights for the respective subblocks as shown in Table 1, the CIIP technique weighted sums the inter-prediction block and intra-prediction block with the determined weights to generate the prediction block of the current block.

TABLE 1

| Subblock index | (Wᵢₙₜᵣₐ, Wᵢₙₜₑᵣ) |
|---|---|
| 0 | (6, 2) |
| 1 | (5, 3) |
| 2 | (3, 5) |
| 3 | (2, 6) |

In Table 1, wᵢₙₜᵣₐ and wᵢₙₜₑᵣ represent the weights of the intra-prediction block and inter-prediction block, respectively.

Meanwhile, when the intra-prediction mode derived by applying TIMD is a non-directional mode, the weights are determined according to the same process as the above-described VVC, and then the CIIP technique uses the determined weights to generate the prediction block of the current block.

### II. INTRA SUB-PARTITIONS (ISP) TECHNIQUE

In VVC, ISP technique divides the current block into smaller subblocks of the same size, shares the intra-prediction mode across all subblocks, but it may allow transforms to be applied to each subblock. At this point, the block may be subdivided horizontally or vertically. ISP technique divides the current block into subblocks based on a flag indicating whether to divide into subblocks and a flag determining whether to divide horizontally or vertically.

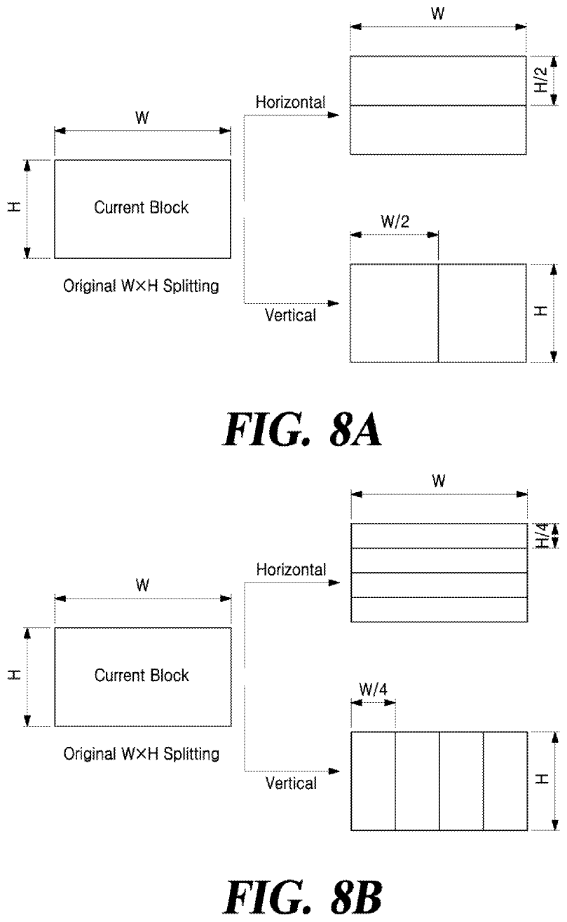

In the following description, as illustrated in FIGS. 8A and 8B, the large block before subdivision is referred to as the current block, and each of the small subdivided blocks is referred to as a subblock. As illustrated in FIGS. 8A and 8B, in ISP mode, the current block may be horizontally split (ISP_HOR_SPLIT) or vertically split (ISP_VER_SPLIT). Hereinafter, ISP_HOR_SPLIT is used interchangeably with horizontal splitting, and ISP_VER_SPLIT is used interchangeably with vertical splitting. In the examples shown in FIGS. 8A and 8B, W and H represent the width and height of the current block, respectively.

When splitting the current block horizontally or vertically, to reduce the intra prediction dependency of too small blocks, the application of ISP may be restricted during subdivision depending on the size of the current block. For example, when the size of the current block is 4×4, ISP is not applied. As shown in FIG. 8A, blocks with sizes of 4×8 or 8×4 may be subdivided into two subblocks of the same shape and size, which is referred to as Half_Split. Additionally, as shown in FIG. 8B, blocks of other sizes may be divided into four subblocks of the same shape and size, which is referred to as Quarter_Split.

The video encoding apparatus encodes the respective subblocks sequentially. At this time, the respective subblocks share the same intra prediction information. For intra prediction for encoding the respective subblocks, the video encoding apparatus can improve compression efficiency by using the reconstructed pixels within the completely decoded subblock as prediction pixel values for subsequent subblocks.

### III. TRANSFORM TECHNIQUES-PRIMARY TRANSFORM TECHNIQUE

As mentioned above, for efficient video compression, quantization or scaling may be additionally applied to residual signals remaining after prediction performed by various prediction techniques. At this time, based on the significance of cognitive visual information inherent in the residual signals, the transform technique may be employed to bring the residual signals clustered together by the frequency component, and then scaling may be performed. However, with non-natural signals such as screen contents, this frequency-based transform technique may be inefficient. In such cases, the transform technique may be omitted, and only scaling may be performed, or encoding/decoding may be performed with no scaling employed.

When the transform is employed in high efficiency video coding (HEVC), DCT-II is used as a transform kernel (hereinafter, used interchangeably with transform type) to transform the residual signals. However, to apply a more appropriate transform technique depending on the diversity of residual signal characteristics, multiple transform selection (MTS) may be used. MTS determines the optimal transform type of one or two out of multiple transform types, and then transforms the block according to the determined transform type. For example, in VVC, as shown in Table 2, further to DCT-II, two other transform types, DCT-VIII and DST-VII, are added so that residual signals may be transformed in various ways.

TABLE 2

| Transform Type | Basis function Tᵢ(j), i, j = 0, 1, ... , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Here, the basis functions constitute a transform matrix defining each transform type. Hereinafter, DCT-II, DCT-VIII, and DST-VII are used interchangeably with DCT2, DCT8, and DST7, respectively.

Meanwhile, the flag for determining whether MTS is to be used may be controlled at the block level. In addition, whether MTS is to be used may be controlled by using the activation flag at the upper SPS level.

When MTS is activated in SPS, a CU-level flag indicating whether MTS is to be used may be represented. Here, MTS may be applied to the luma component. If both the width and height of the transform block (TB) are less than or equal to 32 pixels, and if the coded block flag (CBF), which indicates whether there is a non-zero value among the transform coefficient levels, is true, the CU-level flag may be expressed.

If the CU-level flag is 0, DCT2 is used as kernels in both horizontal and vertical directions. On the other hand, if the CU-level flag is not 0, MTS is used. MTS may be used in two ways: explicit MTS and implicit MTS.

In explicit MTS, the kernel used for TB is explicitly transmitted. Typically, the index of the transform kernel may be transmitted. For example, mts_idx, which is the index of the kernel, may be defined as in Table 2.

TABLE 3

| | | | | | |
|---|---|---|---|---|---|
| mts_idx | 0 | 1 | 2 | 3 | 4 |
| trTypeHor | 0 | 1 | 2 | 1 | 2 |
| trTypeVer | 0 | 1 | 1 | 2 | 2 |

Here, trTypeHor and trTypeVer represent the transform type in the horizontal direction and the transform type in the vertical direction.

Meanwhile, in implicit MTS, the transform type may be determined implicitly even if MTS is not explicitly signaled, for example, in the case of an intra block. In VVC, the transform types in the horizontal and vertical directions may be determined implicitly, as in Equation 2.

trTypeHor=(nTbW>=4&& nTbW<=16)?DST7:DCT2

trTypeVer=(nTbH>=4&& nTbH<=16)?DST7:DCT2 [Equation 2]

Here, nTbW and nTbH represent the width and height of the transform block, respectively.

As an example, when a specific encoding technique is applied, explicit MTS or implicit MTS may be applied. For example, in the case of matrix-weighted intra prediction (MIP), explicit intra MTS may be used. In the case of intra sub-partitions mode (ISP mode), implicit MTS is used, and DST7 or DCT2 is used as the transform type.

Meanwhile, when the transform block includes at least one non-DC coefficient, mts_idx is signaled. For example, when the last significant coefficient position according to the scanning order is greater than 0, mts_idx is signaled. On the other hand, if the transform block contains just one non-DC coefficient, the signaling of mts_idx is omitted, mts_idx=0 is derived, and DCT2 is used as the transform kernel.

The first bin of the signaled mts_idx indicates whether mts_idx is greater than 0. If mts_idx is greater than 0 (i.e., mts_idx indicates one of 1 to 4), a 2-bit fixed-length code is additionally signaled to indicate the signaled mts_idx among the four candidates.

Meanwhile, in the next-generation technique, ECM software, the number and types of MTS kernels are increased, adding DST7, DCT8, DCT5, DST4, DSTI, and identity transform.

### IV. LOW-FREQUENCY NON-SEPARABLE TRANSFORM (LFNST)

The LFNST technique during intra prediction applies a secondary transform to a low-frequency domain within transform coefficients generated by the primary transform of a transform block or transform unit (TU). In the aspect of encoding, the LFNST technique applies a secondary transform to L low-frequency primary transform coefficients out of W×H primary transform coefficients to generate K secondary transform coefficients (where K≤L). Here, L×K is the size of the transform kernel of LFNST. For example, the LFNST technique expresses L low-frequency primary transform coefficients among W×H primary transform coefficients as a I×L vector, and then applies an L×K transform kernel to generate a 1×K vector. Thereafter, the LFNST technique expresses the 1×K vector as a two-dimensional array in the low-frequency domain for subsequent processes such as quantization.

Compared to the primary transform that uses separate transform kernels in the horizontal and vertical directions, the LFNST technique performs a non-separable transform that transforms a one-dimensional vector.

Meanwhile, the type of transform kernel may be determined according to the intra-prediction mode of the current TU, the size of the TU, and the LFNST index (Ifnst_idx). For example, a set of transform kernels may be determined according to the intra-prediction mode (IntraPredMode) of the current TU, as shown in Table 4.

TABLE 4

| IntraPredMode | 1fnstTrSetIdx |
|---|---|
| IntraPredMode < 0 | 1 |
| 0 ≤ IntraPredMode ≤ 1 | 0 |
| 2 ≤ IntraPredMode ≤ 12 | 1 |
| 13 ≤ IntraPredMode ≤ 23 | 2 |
| 24 ≤ IntraPredMode ≤ 44 | 3 |
| 45 ≤ IntraPredMode ≤ 55 | 2 |
| 56 ≤ IntraPredMode ≤ 80 | 1 |
| 81 ≤ IntraPredMode ≤ 83 | 0 |

Here, the intra-prediction mode (IntraPredMode) follows the example of FIG. 3B. Additionally, IfnstTrSetIdx is an index indicating a kernel set. In Table 4, IntraPredMode, when it is 81, 82, and 83, indicates Cross-component Linear Model (CCLM) prediction modes.

Two types of kernels are defined for each kernel set, IfnstTrSetIdx. Which kernel is to be selected between the two types of kernels may be indicated by the LFNST index. The LFNST index being 0 means that LFNST is not performed, and when the LFNST index is 1 or 2, a different LFNST kernel within the same kernel set is applied. Since there is one more kernel set depending on the size of the TU, there are 4×2×2=16 transform kernels in total. The kernel sizes of LFNST are defined as 16×16 and 16×48. Additionally, the kernel size may be adjusted according to the TU size, as shown in Table 5.

TABLE 5

| | Size of Transform |
|---|---|
| Size of Block | (K × L) |
| 4 × 4 | 8 × 16 |
| 4 × N, N × 4 (N > 8) | 16 × 16 |
| 8 × 8 | 8 × 48 |
| larger than 8 × 8 | 16 × 48 |

Meanwhile, when a DCT2/DCT2 transform kernel is applied as the primary transform to an intra-predicted TU in VVC, the LFNST technique may be employed as the secondary transform.

In ECM, a next-generation technique, when encoding TUs based on intra prediction, if the block size is small (e.g., 4×4, 4×8, 8×4, 4×16, 16×4, 8×8, 8×16, 16×8), an non-separable primary transform technique may be employed. Additionally, when the block size is large and the DCT2/DCT2 transform kernel is applied to the block as the primary transform, the LFNST technique may be employed.

Hereinafter, TU is used interchangeably with transform block.

The following embodiments are described with a focus on the video decoding apparatus, but they may be implemented in the same or similar manner in the video encoding apparatus.

### V. EMBODIMENTS ACCORDING TO THE PRESENT DISCLOSURE

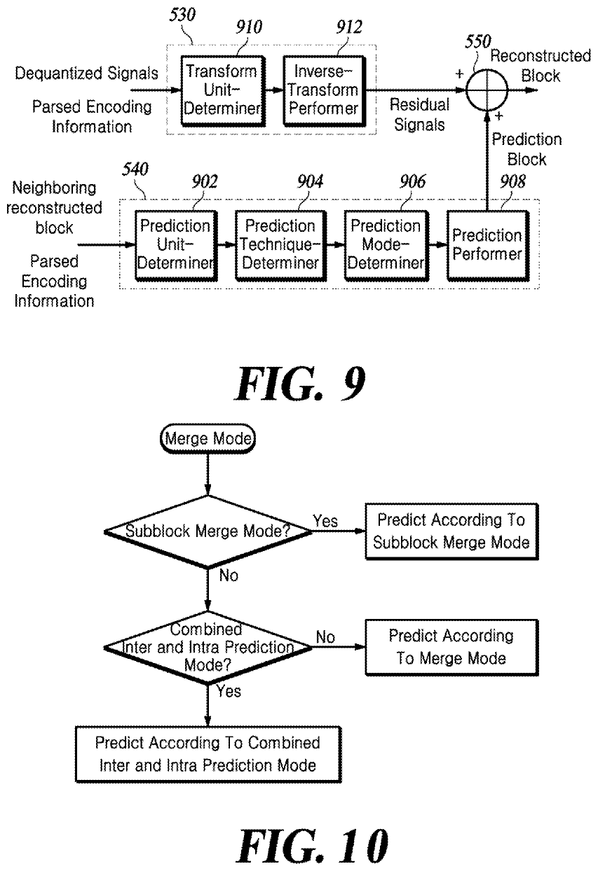

FIG. 9 is a block diagram illustrating a detailed portion of a video decoding apparatus according to at least one embodiment of the present disclosure.

The video decoding apparatus according to some embodiments may determine prediction and transform units, and in response to a current block corresponding to the determined unit, may perform a prediction and an inverse transform by using a determined prediction technique and prediction mode, to finally generate a reconstructed block of the current block. The operations illustrated in FIG. 9 may be performed by the inverse transformer 530, the predictor 540, and the adder 550 of the video decoding apparatus. On the other hand, the same operations as illustrated in FIG. 9 may be performed by the inverse transformer 165, the picture splitter 110, the predictor 120, and the adder 170 of the video encoding apparatus. In this case, the video decoding apparatus uses encoding information parsed from the bitstream, but the video encoding apparatus may use encoding information set from a high level in terms of minimizing bit rate distortion. Hereinafter, for convenience, the embodiments are described centering on the video decoding apparatus.

As illustrated in FIG. 5, the predictor 540 includes the intra predictor 542 and the inter predictor 544, depending on the prediction technique, but as illustrated in FIG. 9, the predictor 540 may include all or part of a prediction unit-determiner 902, a prediction technique-determiner 904, a prediction mode-determiner 906, and a prediction performer 908.

If the color format of the input video is a YUV format (YUV420, YUV411, YUV422, YUV444, or the like), the video decoding apparatus may perform prediction and reconstruction of the luma component, and then may perform prediction and reconstruction of the chroma component. In this way, the luma component and the chroma component may be sequentially reconstructed by the components illustrated in FIG. 9. On the other hand, if the color format of the input video is RGB, the video encoding apparatus may perform a color format conversion from RGB to YUV, and then may encode the converted video. Here, in the YUV format, the color format represents a correspondence between pixels in the luma component and pixels in the chroma component.

The prediction unit-determiner 902 determines a prediction unit (PU). The prediction technique-determiner 904, in response to the prediction unit, determines a prediction technique, e.g., intra prediction, inter prediction, or intra block copy (IBC) mode, palette mode, or the like. The prediction mode-determiner 906 determines a detailed prediction mode for the prediction technique. The prediction performer 908 generates a prediction block of the current block according to the determined prediction mode.

The inverse transformer 530 includes a transform unit-determiner 910 and an inverse transform performer 912. The transform unit-determiner 910 determines a transform unit (TU) in response to the dequantized signals of the current block, and the inverse transform performer 912 inversely transforms the transform unit represented by the dequantized signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 902 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed in response to the prediction unit of the chroma component.

The prediction technique-determiner 904 determines a prediction technique for the prediction units. As described above, the prediction technique may be one of inter prediction, intra prediction, IBC mode, and palette mode. In this case, the prediction technique for the chroma component may be determined to be the same as the prediction technique of the corresponding luma component without signaling and parsing any additional information.

As an example, when the slice type is an intra prediction slice, the video decoding apparatus determines one of intra prediction, IBC, palette mode, or the like, as the prediction technique. Depending on the embodiment, one or more of the prediction technique candidates may not be used or may be implicitly not used depending on the flag.

In one example, if the prediction technique of the current block is not intra prediction, the video decoding apparatus parses the 1-bit flag information. If the parsed flag indicates a skip mode, the video decoding apparatus may determine the prediction mode of the current block to be an inter prediction merge mode or an IBC merge mode. In the skip mode, the video decoding apparatus may also use the predicted signals as reconstructed signals, while skipping an inverse transform, i.e., without parsing residual signals.

On the other hand, if the parsed flag does not indicate a skip mode in response to the current block, the prediction technique-determiner 904 may determine one of the prediction techniques, such as inter prediction, intra prediction, IBC mode, palette mode, or the like, by parsing a series of 1-bit flags to be the prediction technique of the current block.

For example, if skip mode is not applied to the current block and the inter prediction or IBC mode is determined to be the prediction technique, the video decoding apparatus parses a 1-bit flag. The video decoding apparatus may determine, based on the parsed flag, the prediction mode of the current block to be the regular merge mode or AMVP (advanced motion vector prediction) mode. Some embodiments may omit parsing of flags indicating the application of a specific technique, based on one or more of the following elements: the size of the current block, the flags of the sequence parameter set, and the type of the current channel, that is luma component or chroma component.

The prediction mode-determiner 906 determines a detailed prediction mode for the prediction technique.

As an example, when the prediction technique for the current block is inter prediction, the prediction mode-determiner 906 may parse the 1-bit flag to determine whether merge mode is to be used. When the prediction technique for the current block is skip mode, the prediction mode-determiner 906 may implicitly derive the merge mode flag of 1 without parsing the flag indicating whether the prediction technique is merge mode (hereinafter referred to as the ‘merge mode flag’).

FIG. 10 is a diagram illustrating the determination of the merge mode according to at least one embodiment of the present disclosure.

As illustrated in FIG. 10, if the prediction mode of the current block is merge mode, the prediction mode-determiner 906 may parse the 1-bit flag to determine whether to perform prediction according to subblock merge mode. In the subblock merge mode, the prediction mode-determiner 906 determines the motion vector for each subblock. Hereinafter, the flag indicating prediction according to the subblock merge mode is referred to as the subblock merge mode flag.

When the subblock merge mode flag is 0, the prediction mode-determiner 906 further parses a flag indicating whether to perform the combined inter and intra prediction mode, i.e., the CIIP mode (hereinafter referred to as the “combined inter and intra prediction flag” or “CIIP flag”), to determine whether the CIIP mode is to be used. Depending on the embodiment, whether the CIIP mode is to be used may be implicitly determined based on the size and aspect ratio of the current block.

As an example, regardless of whether the subblock merge mode is to be used, the prediction mode-determiner 906 may parse the combined inter and intra prediction flag to determine whether the CIIP mode is to be used.

The prediction performer 908 uses the determined prediction technique and prediction mode as basis for generating the prediction block of the current block. If the CIIP mode is determined as the prediction mode, the video decoding apparatus generates the prediction block of the current block as follows.

The video decoding apparatus determines a motion vector for inter prediction. After decoding the merge index, the video decoding apparatus uses the merge index for deriving a motion vector to perform motion compensation of the current block. Some embodiments may use the CIIP mode, when they may use merge candidates as many as or less than the number of merge candidates in the regular merge mode to reduce the number of bits consumed to encode the merge index. To perform effective inter prediction based on a smaller number of merge candidates, template matching-based organization of merge candidates may be performed.

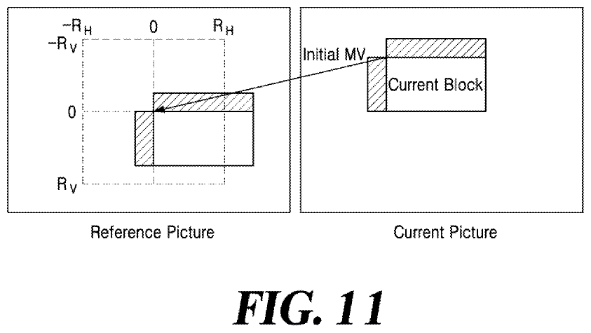

The template matching-based organization of merge candidates, as illustrated in FIG. 11, accesses the reference picture based on the initial motion vector (MV) and generates a refined motion vector that minimizes the template matching cost between the template of the current block and the template within the reference picture. The template is predefined according to an agreement between the video encoding apparatus and the video decoding apparatus. The video decoding apparatus uses the refined motion vector to perform motion compensation for the current block. When there is more than one template matching-based merge candidate, the video decoding apparatus parses the template matching merge index and determines the initial motion vector based on the parsed template matching merge index. In the example of FIG. 11, RH defines a search area for template matching in the neighborhood of the block indicated by the initial motion vector.

As another example, the video decoding apparatus may construct a candidate list in the regular merge mode and then secondly construct the candidate list by using a preset number of candidates with low template matching costs. Then, the video decoding apparatus parses the merge index indicating one of the preset number of candidates and derives the final motion vector according to the parsed merge index.

The video decoding apparatus derives the intra-prediction mode when the CIIP mode is selected.

As an example, the intra-prediction mode may be implicitly determined to be a specific mode (e.g., planar mode) in accordance with an agreement between the video encoding apparatus and the video decoding apparatus. The video decoding apparatus may calculate gradient values based on neighboring reconstructed reference samples and may derive the intra-prediction mode based on the calculated gradient values. Alternatively, the video decoding apparatus uses candidate intra-prediction modes to perform intra prediction on a template containing reconstructed reference samples. The video decoding apparatus may use as the basis the metrics such as sum of absolute differences (SAD) and sum of absolute transformed differences (SATD) between the template and the prediction block of the template, for deriving the optimal intra-prediction mode from among the candidate intra-prediction modes. In this case, neighboring reference samples of the template are used to generate the prediction block of the template. Some embodiments may derive the optimal intra mode among N intra-prediction modes based on the above-described metrics for M (M<=N) candidate intra-prediction modes defined according to an agreement between the video encoding apparatus and the video decoding apparatus. The N intra-prediction modes may be the intra-prediction modes illustrated in FIG. 3A.

The video decoding apparatus may determine, based on the current block's size, aspect ratio, and intra-prediction mode, whether subblock partitioning is to be performed and the partition shape.

As an example, the video decoding apparatus may implicitly skip subblock partitioning when the prediction mode of the current block is a skip mode that does not reconstruct residual signals.

As another example, the video decoding apparatus may determine the partition shape of the subblock based on the derived intra-prediction mode.

As an example, the video decoding apparatus may determine whether the current block is to be subblock-partitioned based on the derived intra-prediction mode and the size of the current block. When the derived intra-prediction mode is a directional mode, the partitioning direction may be determined based on whether the directional mode is closer to the vertical direction or the horizontal direction. Hereinafter, a prediction mode closer to the horizontal direction is referred to as a horizontal directional prediction mode, and a prediction mode closer to the vertical direction is referred to as a vertical directional prediction mode. The horizontal directional prediction mode is when −14≤Modeᵢₙₜᵣₐ≤−1 and 2≤Modeᵢₙₜᵣₐ<34, as illustrated in FIG. 3B, and the vertical directional prediction mode is when 34≤Modeᵢₙₜᵣₐ≤80.

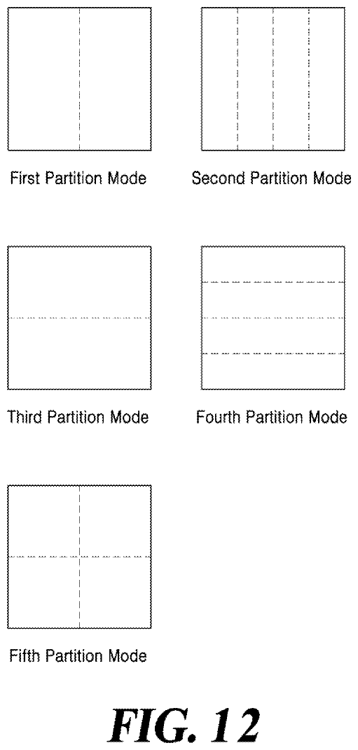

FIG. 12 is a diagram illustrating partition shapes of the current block, according to at least one embodiment of the present disclosure.

In the horizontal directional prediction mode, the video decoding apparatus determines the partition shape of the current block according to the first partition mode or the second partition mode in the vertical direction as illustrated in FIG. 12, and partitions the current block according to the determined partition shape. The partition shape may always be determined according to the first partition mode or the second partition mode following the agreement between the video encoding apparatus and the video decoding apparatus, or it may be determined according to the first partition mode or the second partition mode based on the width (W) of the current block. For example, the video decoding apparatus may skip partitioning when W<TH₀, may determine the partition shape according to the first partition mode when TH₀≤W<TH₁, and may determine the partition shape according to the second partition mode when TH₁≤W. Here, TH₀ and TH₁ represent preset thresholds and may be defined in advance according to an agreement between the video encoding apparatus and the video decoding apparatus. The first partition mode represents a vertical binary split, and the second partition mode represents a vertical quarter split.

In the vertical directional prediction mode, the video decoding apparatus determines the partition shape of the current block according to the third partition mode or fourth partition mode in the horizontal direction, as shown in FIG. 12, and divides the current block according to the determined partition shape. The partition shape may always be determined according to the third partition mode or the fourth partition mode following the agreement between the video encoding apparatus and the video decoding apparatus, or it may be determined according to the third partition mode or the fourth partition mode based on the height (H) of the current block. For example, the video decoding apparatus may skip partitioning when H<TH₀, may determine the partition shape according to the third partition mode when TH₀≤H<TH₁, and may determine the partition shape according to the fourth partition mode when TH₁≤H. Here, TH₀ and TH₁ represent preset thresholds and may be defined in advance according to an agreement between the video encoding apparatus and the video decoding apparatus. The third partition mode represents a horizontal binary split, and the fourth partition mode represents a horizontal quarter split.

As another example, when the derived intra-prediction mode is a non-directional mode, the video decoding apparatus may implicitly skip subblock partitioning. Alternatively, the video decoding apparatus may use the fifth partition mode illustrated in FIG. 12 to determine the partition shape of the current block and partition the current block according to the determined partition shape. The fifth partition mode represents a horizontal vertical quarter split.

If the width (W) and/or height (H) of the current block is smaller than the preset thresholds, the video decoding apparatus may implicitly skip subblock partitioning.

The video decoding apparatus determines the weights for the CIIP mode based on one or more elements of information, such as the number of intra-prediction blocks among neighboring blocks, the number of inter-prediction blocks among the neighboring blocks, the intra-prediction mode of the neighboring blocks, whether the neighboring blocks are to be subblock-partitioned, the derived intra-prediction mode, the size of the current block, and whether the current block is to be subblock-partitioned.

An example describes a case where the current block is intra-predicted without being split into subblocks. The video decoding apparatus determines the weights for the inter-prediction and intra-prediction based on one or more elements of information, such as the number of intra-prediction blocks among the neighboring blocks, the number of inter-prediction blocks among the neighboring blocks, the intra-prediction mode of the neighboring blocks, the whether the neighboring blocks are to be subblock-partitioned, the derived intra-prediction mode, and the size of the current block.

When the derived intra-prediction mode is a non-directional mode, the video decoding apparatus may determine the weights based on the number of blocks encoded according to intra prediction and inter prediction among predefined neighboring blocks, following an agreement between the video encoding apparatus and the video decoding apparatus. Here, the positions of the neighboring blocks for counting the number of blocks may vary. The weights based on the counted number of blocks may be expressed as shown in Table 6.

TABLE 6

| Condition | Wᵢₙₜᵣₐ, Wᵢₙₜₑᵣ) |
|---|---|
| Nᵢₙₜᵣₐ > Nᵢₙₜₑᵣ | (2^{p} - q₀, q₀) |
| Nᵢₙₜᵣₐ = Nᵢₙₜₑᵣ | (2^{p-1}, 2^{p-1}) |
| Nᵢₙₜᵣₐ < Nᵢₙₜₑᵣ | (q₁, 2^{p} - q₁) |

In Table 6, wᵢₙₜᵣₐ and wᵢₙₜₑᵣ represent the weights for the intra-prediction block and inter-prediction block, respectively. Nᵢₙₜᵣₐ and Nᵢₙₜₑᵣ respectively represent the number of blocks encoded according to intra prediction and the number of blocks encoded according to inter prediction among neighboring blocks. 2^{p} is used to divide the predicted value based on the weighted summation. q₀(2^{p}−q₀>q₀) and q₁ (2^{p}−q₁>q₁) may be predefined according to an agreement between the video encoding apparatus and the video decoding apparatus.

As another example, when the derived intra-prediction mode is a directional mode, the video decoding apparatus divides the current block into a preset number of sub-areas depending on whether the directionality is closer to the vertical direction or the horizontal direction. Then, the video decoding apparatus determines the weight for the intra prediction and the weight for the inter prediction for each sub-area.

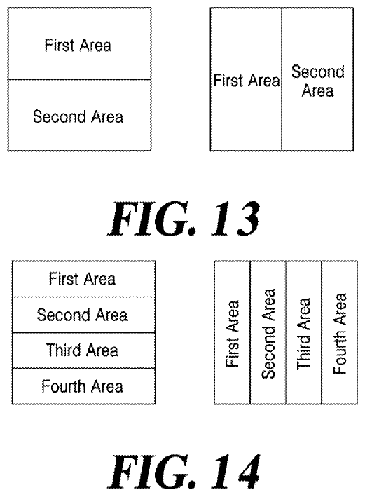

The example in FIG. 13 shows the divided sub-areas when the preset number is 2. When the derived intra-prediction mode is a vertical directional prediction mode, the current block is horizontally divided into sub-areas as shown in the left example of FIG. 13. When the derived intra-prediction mode is a horizontal directional prediction mode, the current block may be vertically divided into sub-areas as shown in the right example of FIG. 13. The weights in each sub-area may be illustrated by Table 7.

TABLE 7

| Sub-area index | (Wᵢₙₜᵣₐ, Wᵢₙₜₑᵣ) |
|---|---|
| 1 | (2^{p} - q₂, q₂) |
| 2 | (q₂, 2^{p} - q2) |

In Table 7, 2^{p} is used to divide the predicted value according to the weighted sum. q₂ (2^{p}-q₂>q₂) may be predefined according to an agreement between the video encoding apparatus and the video decoding apparatus.

The example in FIG. 14 shows the divided sub-areas when its preset number is 4. When the derived intra-prediction mode is the vertical directional prediction mode, the current block is horizontally divided into sub-areas as shown in the left example of FIG. 14, and when the derived intra-prediction mode is the horizontal directional prediction mode, the current block may be vertically divided into sub-areas as shown in the right example of FIG. 14. The weights in each sub-area may be illustrated by Table 8.

TABLE 8

| Sub-area index | (Wᵢₙₜᵣₐ, Wᵢₙₜₑᵣ) |
|---|---|
| 1 | (2^{p} - q₃, q₃) |
| 2 | (2^{p} - q₄, q₄) |
| 3 | (q₅, 2^{p} - q₅) |
| 4 | (q₆, 2^{p} - q₆) |

In Table 8, 2P is used to divide the predicted value according to the weighted summation. qᵢ (2^{p}−qᵢ>qᵢ, i is 3 to 6) may be predefined according to an agreement between the video encoding apparatus and the video decoding apparatus.

The above-described preset number may be defined according to an agreement between the video encoding apparatus and the video decoding apparatus, or determined based on the width/height of the current block. For example, when the derived intra-prediction mode of the current block is a vertical directional mode, the height H of the current block is used. The video decoding apparatus skips sub-area division when H<TH_{div0}, performs horizontal division into two sub-areas when TH_{div0}≤H<TH_{div1}, and performs horizontal division into four sub-areas when TH_{div1}≤H. Here, TH_{div0} and TH_{div1} represent preset thresholds, which may be predefined according to an agreement between the video encoding apparatus and the video decoding apparatus.

Additionally, when the derived intra-prediction mode of the current block is a horizontal directional mode, the height W of the current block is used. The video decoding apparatus skips sub-area division if W<TH_{div0}, performs vertical division into two sub-areas if TH_{div0}≤W<TH_{div1}, and performs vertical division into four sub-areas if TH_{div1}≤W. Here, TH_{div0} and TH_{div1} represent preset thresholds, which may be predefined according to an agreement between the video encoding apparatus and the video decoding apparatus.

Another example describes the case where the current block is intra-predicted after being partitioned into subblocks. The video decoding apparatus calculates the weights in the same way as when the block is not partitioned into subblocks. Alternatively, the video decoding apparatus may determine the weights regardless of the intra-prediction mode but based on the number of intra-prediction blocks and inter-prediction blocks of neighboring blocks.

When the current block is intra-predicted after being partitioned into subblocks, the video decoding apparatus decodes the residual signals of the subblock after predicting the subblock, and reconstructs the subblock by summing the predicted signals of the subblock and the decoded residual signals. Therefore, instead of using the same reference samples, the video decoding apparatus uses the reconstructed reference samples of the previous subblock for each subblock to perform intra prediction. Therefore, after dividing into sub-areas according to the intra-prediction mode, the video decoding apparatus replaces the assigning of smaller weights to farther sub-areas away from the reference samples with the deriving of the same weight for all subblocks. When applying the same weight to all subblocks, the video decoding apparatus may calculate the weights according to the example related to Table 6.

The video decoding apparatus generates the final predicted signals of the current block based on the weights determined as described above, as in Equation 3.

P_{CIIP}=(wᵢₙₜₑᵣ×Pᵢₙₜₑᵣ+wᵢₙₜᵣₐ×Pᵢₙₜᵣₐ+2⁻¹)>p [Equation 3]

When the current block is intra-predicted after being partitioned into subblocks, the video decoding apparatus may generate intra predicted signals of the current subblock by using the reconstructed reference samples of the previous subblock.

Meanwhile, the video decoding apparatus decodes from the bitstream the transform coefficients of the current block. When the current block is intra-predicted after being partitioned into subblocks, the video decoding apparatus decodes the coded block flag (CBF) for each subblock and determines whether non-zero residual values exist in the subblock based on the decoded CBF. When reconstructing each of the subblocks, one or more subblocks need to have a CBF flag of 1. Therefore, where there are all 0 CBFs of the subblocks preceding the last subblock among the preset number of subblocks to be sequentially reconstructed, the video decoding apparatus implicitly determines the CBF value of the last subblock to be 1.

The video decoding apparatus reconstructs the residual signals by inverse transforming the transform coefficients of the current block. When the block to be inverse transformed is predicted according to the CIIP mode, the video decoding apparatus may determine the inverse transform kernels for the primary transform and/or secondary transform based on the intra-prediction mode as follows. Here, the secondary transform refers to the LFNST (Low-frequency Non-separable Transform) as described above.

As an example, the video decoding apparatus determines the inverse transform kernels by using the kernel determination process according to the inter-prediction mode, regardless of the intra-prediction mode. For example, the video decoding apparatus may follow Table 3 to explicitly determine the inverse transform kernels of the primary transform.

In another example, the video decoding apparatus determines the inverse transform kernels based on the intra-prediction mode determined during prediction according to the CIIP mode.

As yet another example, the video decoding apparatus calculates gradient values based on the final predicted signals predicted according to the CIIP mode, and then uses the calculated gradient values to derive the intra-prediction mode of the current block. Subsequently, based on the derived intra-prediction mode, the video decoding apparatus determines inverse transform kernels.

Meanwhile, the video decoding apparatus may determine the inverse transform kernels of the secondary transform and/or non-separable primary transform (NSPT) for the current block predicted according to the CIIP mode, as follows. The video decoding apparatus calculates gradient values based on the intra-prediction block predicted in the CIIP mode, the inter-prediction block predicted in the CIIP mode, or the weighted summed final predicted signals, and then uses the calculated gradient values to derive the intra-prediction mode of the current block. Subsequently, based on the derived intra-prediction mode, the video decoding apparatus determines the inverse transform kernels of the secondary transform and/or the non-separable primary transform.

As another example, the video decoding apparatus may determine the inverse transform kernels of the secondary transform and/or the non-separable primary transform (NSPT) for the current block predicted according to inter prediction, as follows. The video decoding apparatus calculates gradient values based on the prediction block generated according to the inter prediction, and then uses the calculated gradient values to derive the intra-prediction mode of the current block. Thereafter, based on the derived intra-prediction mode, the video decoding apparatus determines the inverse transform kernels of the secondary transform and/or the non-separable primary transform.

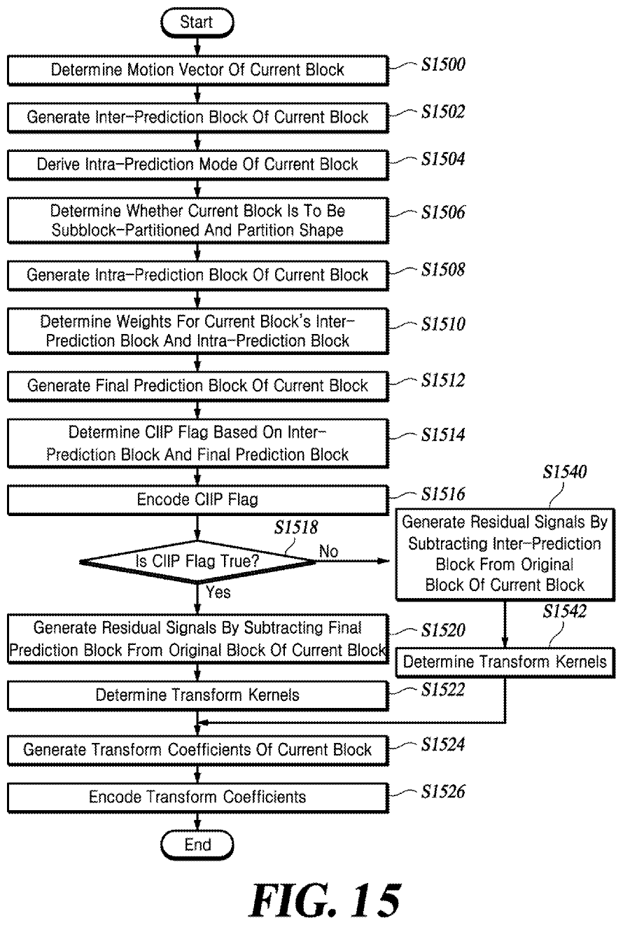

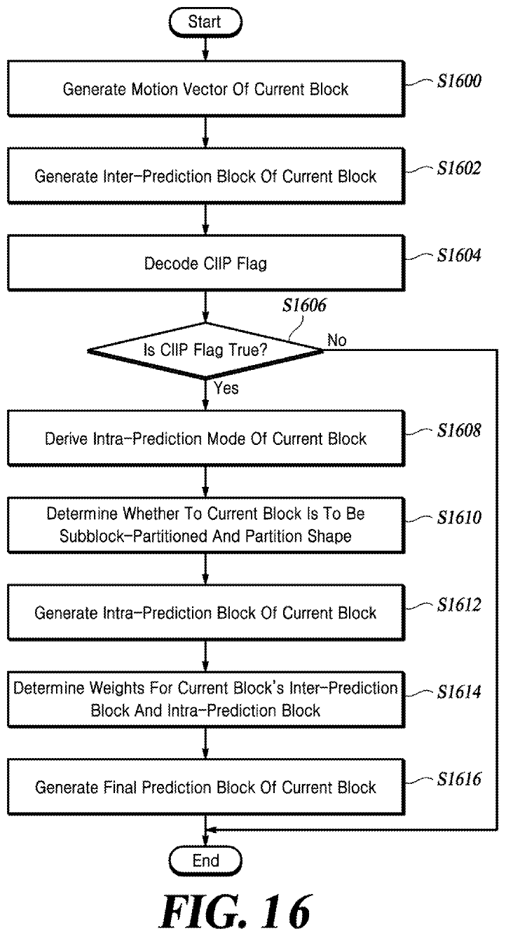

The following describes, by using the illustrations of FIGS. 15 and 16, the encoding and reconstructing methods of the current block, which use the CIIP mode according to the present disclosure.

FIG. 15 is a flowchart of a method of encoding a current block by the video encoding apparatus, according to at least one embodiment of the present disclosure.

The video encoding apparatus determines the motion vector of the current block (S1500).

The video encoding apparatus generates a list of merge candidates for the current block and derives the initial motion vectors of the current block from the merge candidates in the list of merge candidates. The video encoding apparatus refines the initial motion vectors based on template matching and determines the refined initial motion vector that is optimal in terms of rate distortion optimization as the motion vector of the current block. The video decoding apparatus derives from the list of merge candidates a merge index indicating the initial motion vector corresponding to the motion vector of the current block. Subsequently, the video encoding apparatus encodes the merge index.

The video encoding apparatus generates an inter-prediction block of the current block based on the motion vector (S1502).

The video encoding apparatus derives the intra-prediction mode of the current block (S1504).

The video encoding apparatus determines whether the current block is to be subblock-partitioned and a partition shape of the current block based on the size and intra-prediction mode of the current block (S1506).

The video encoding apparatus generates the intra-prediction block of the current block according to the whether the current block is to be subblock-partitioned and intra-prediction mode of the current block (S1508).

If the current block is not partitioned into subblocks, the video encoding apparatus generates an intra-prediction block of the current block according to the derived intra-prediction mode.

If the current block is partitioned into subblocks, the video encoding apparatus performs that partitioning according to the partition shape. The video encoding apparatus generates predicted signals of the subblocks based on the intra-prediction mode. At this time, the video encoding apparatus may use the reconstructed reference samples of the previous subblock of the current subblock to generate predicted signals of the current subblock.

The video encoding apparatus determines the weights for the inter-prediction mode and the intra-prediction mode of the current block based on one or more of the number of decoded blocks according to intra prediction among the neighboring blocks of the current block, the number of blocks decoded according to inter prediction among the neighboring blocks, the intra-prediction mode of the current block, the size of the current block, and whether the current block is to be subblock-partitioned (S1510).

The video encoding apparatus weighted sums the inter-prediction block and intra-prediction block of the current block based on the weights to generate the final prediction block of the current block (S1512).

The video encoding apparatus determines the CIIP flag based on the inter-prediction block and final prediction block of the current block (S1514). Here, the CIIP flag indicates whether the CIIP mode is to be used. In terms of rate-distortion optimization, the video encoding apparatus determines the CIIP flag. For example, if the inter-prediction block is optimal, the CIIP flag is determined to be false. On the other hand, if the final prediction block is optimal, the CIIP flag is determined to be true.

The video encoding apparatus encodes the CIIP flag (S1516).

The video encoding apparatus checks the CIIP flag (S1518). If the CIIP flag is true (Yes in S1518), the video encoding apparatus performs the following steps.

The video encoding apparatus subtracts the final prediction block from the original block of the current block to generate residual signals (S1520).

The video encoding apparatus determines transform kernels for the primary transform and/or secondary transform of the current block (S1522).

As an example, the video encoding apparatus calculates gradient values based on the final prediction block, and then uses the calculated gradient values to derive the intra-prediction mode of the current block. The video encoding apparatus may determine the transform kernels based on the derived intra-prediction mode.

The video encoding apparatus uses the transform kernels to transform residual signals, thereby generating transform coefficients of the current block (S1524).

The video encoding apparatus encodes the transform coefficients (S1526).

On the other hand, if the CIIP flag is false (No in S1518), the video encoding apparatus performs the following steps.

The video encoding apparatus subtracts the inter-prediction block from the original block of the current block to generate residual signals (S1540).

The video encoding apparatus determines transform kernels for the primary transform and/or secondary transform of the current block (S1542).

The video encoding apparatus uses the transform kernels to transform the residual signals, thereby generating transform coefficients of the current block. Thereafter, the video encoding apparatus encodes the transform coefficients.

FIG. 16 is a flowchart of a method of reconstructing a current block by the video decoding apparatus, according to at least one embodiment of the present disclosure.

The video decoding apparatus generates a motion vector of the current block (S1600).

The video decoding apparatus decodes the merge index of the current block from the bitstream and generates a list of merge candidates of the current block. The video decoding apparatus uses the merge index to derive the initial motion vector of the current block from the merge candidates in the list of merge candidates. The video decoding apparatus refines the initial motion vector based on template matching to generate the motion vector of the current block.

The video decoding apparatus generates an inter-prediction block of the current block based on the motion vector (S1602).

The video decoding apparatus decodes the CIIP flag from the bitstream (S1604). Here, the CIIP flag indicates whether the CIIP mode is to be used.

The video decoding apparatus checks the CIIP flag (S1606).

If the CIIP flag is true (Yes in S1606), the video decoding apparatus performs the following steps.

The video decoding apparatus derives the intra-prediction mode of the current block (S1608).

The video decoding apparatus determines whether the current block is to be subblock-partitioned and the partition shape of the current block based on the size and intra-prediction mode of the current block (S1610).

The video decoding apparatus generates intra-prediction blocks of the current block according to the whether the current block is to be subblock-partitioned and the intra-prediction mode of the current block (S1612).

If the current block is not partitioned into subblocks, the video decoding apparatus generates an intra-prediction block of the current block according to the derived intra-prediction mode.

If the current block is partitioned into subblocks, the video decoding apparatus performs that partitioning according to the partition shape. The video decoding apparatus generates predicted signals of the subblocks based on the intra-prediction mode. At this time, the video decoding apparatus may use the reconstructed reference samples of the previous subblock of the current subblock to generate predicted signals of the current subblock.

The video decoding apparatus determines the weights for the inter-prediction block and the intra-prediction block of the current block based on one or more of the number of decoded blocks according to intra prediction among the neighboring blocks of the current block, the number of blocks decoded according to inter prediction among the neighboring blocks, the intra-prediction mode of the current block, the size of the current block, and whether the current block is to be subblock-partitioned (S1614).

The video decoding apparatus weighted sums the inter-prediction block and intra-prediction block of the current block based on the weights to generate the final prediction block of the current block (S1616).

The video decoding apparatus decodes the transform coefficients of the current block from the bitstream and determines the inverse transform kernels of the primary transform and/or secondary transform of the current block.

As an example, the video decoding apparatus calculates gradient values based on the final prediction block and then use the calculated gradient values to derive the intra-prediction mode of the current block. The video decoding apparatus may determine transform kernels based on the derived intra-prediction mode.

The video decoding apparatus uses the inverse transform kernels to reconstruct residual signals from the transform coefficients of the current block, and sums the final prediction block of the current block and the residual signals to generate the reconstructed block of the current block.

On the other hand, when the CIIP flag is false (No in S1606), the video decoding apparatus performs the following steps.

The video decoding apparatus decodes the transform coefficients of the current block from the bitstream and determines the inverse transform kernels for the primary transform and/or secondary transform of the current block. The video decoding apparatus uses the inverse transform kernels to reconstruct the residual signals from the transform coefficients of the current block, and sums the inter-prediction block of the current block and the residual signals to generate the reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

120: predictor
540: predictor
902: prediction unit-determiner
904: prediction technique-determiner
906: prediction mode-determiner
908: prediction performer

### CROSS-REFERENCE TO RELATED APPLICATIONS

This application claims priority to and the benefit of Korean Patent Application No. 10-2023-0060321 filed on May 10, 2023, and Korean Patent Application No. 10-2024-0030640, filed on Mar. 4, 2024, the entire contents of each of which are incorporated herein by reference.

1. A method of reconstructing a current block by a video decoding apparatus, the method comprising:
generating a motion vector of the current block;
generating an inter-prediction block of the current block based on the motion vector;
deriving an intra-prediction mode of the current block;
determining whether the current block is to be subblock-partitioned and a partition shape based on a size of the current block and the intra-prediction mode;
generating an intra-prediction block of the current block based on the whether the current block is to be subblock-partitioned, and the intra-prediction mode;
determining weights for the inter-prediction block and the intra-prediction block based on one or more of a number of blocks decoded according to intra prediction among neighboring blocks of the current block, a number of blocks decoded according to inter prediction among the neighboring blocks, the intra-prediction mode, the size of the current block, and the whether the current block is to be subblock-partitioned; and
generating a final prediction block of the current block by weighted summing the inter-prediction block and the intra-prediction block based on the weights.

2. The method of claim 1, further comprising:
decoding, from a bitstream, a combined inter and intra prediction flag (CIIP flag) that indicates whether a CIIP mode is to be used; and
checking the CIIP flag,
wherein the method proceeds, when the CIIP flag is true, with deriving the intra-prediction mode of the current block through generating the final prediction block of the current block.

3. The method of claim 1, wherein generating the motion vector of the current block comprises:
decoding a merge index of the current block from a bitstream;
generating a list of merge candidates of the current block;
deriving, by using the merge index, an initial motion vector of the current block from the merge candidates in the list of merge candidates; and
refining the initial motion vector based on template matching.

4. The method of claim 1, wherein deriving the intra-prediction mode of the current block comprises:
calculating gradient values based on neighboring reconstructed reference samples of the current block; and
deriving the intra-prediction mode based on the gradient values.

5. The method of claim 1, wherein determining the weights comprises, when the intra-prediction mode is a non-directional mode:
determining the weights based on a number of neighboring blocks decoded according to the intra prediction and a number of neighboring blocks decoded according to the inter prediction among predefined neighboring blocks.

6. The method of claim 1, wherein determining the weights comprises, when the intra-prediction mode is a horizontal directional prediction mode:
vertically dividing the current block into a preset number of sub-areas based on a width of the current block, and assigning a larger weight to intra-predicted signals within such a sub-area that is located closer to a left side.

7. The method of claim 1, wherein determining the weights comprises, when the intra-prediction mode is a vertical directional prediction mode:
horizontally dividing the current block into a preset number of sub-areas based on a height of the current block, and assigning a larger weight to intra-predicted signals within such a sub-area that is located closer to a top side.

8. The method of claim 1, wherein generating the intra-prediction block comprises, when the current block is to be subblock-partitioned:
partitioning the current block into subblocks according to the partition shape; and
generating predicted signals of the subblocks based on the intra-prediction mode.

9. The method of claim 8, wherein generating the intra-prediction block comprises:
generating predicted signals of a current subblock by using reconstructed reference samples of a previous subblock of the current subblock.

10. The method of claim 8, wherein determining the weights comprises:
applying common weights to the subblocks, wherein the common weights are determined based on a number of neighboring blocks decoded according to the intra prediction and a number of neighboring blocks decoded according to the inter prediction among predefined neighboring blocks.

11. The method of claim 1, wherein determining whether the current block is to be subblock-partitioned and the partition shape comprises:
when the intra-prediction mode is a horizontal directional prediction mode, determining whether the current block is to be subblock-partitioned and the partition shape of the current block based on a width of the current block, and when the intra-prediction mode is a vertical directional prediction mode, determining whether the current block is to be subblock-partitioned and the partition shape of the current block based on a height of the current block.

12. The method of claim 1, wherein determining whether the current block is to be subblock-partitioned and the partition shape comprises:
when the intra-prediction mode is a non-directional mode, holding from partitioning the current block or partitioning the current block in a horizontal vertical quarter split.

13. The method of claim 1, further comprising:
decoding transform coefficients of the current block from a bitstream;
determining inverse transform kernels for a primary transform and/or a secondary transform of the current block;
reconstructing residual signals from the transform coefficients of the current block by using the inverse transform kernels; and
generating a reconstructed block of the current block by summing the final prediction block and the residual signals.

14. The method of claim 13, wherein determining the inverse transform kernels comprises:
calculating gradient values based on the final prediction block;
deriving the intra-prediction mode of the current block by using the gradient values; and
determining the inverse transform kernels based on the derived intra-prediction mode.

15. The method of claim 13, wherein determining the inverse transform kernels comprises:
calculating gradient values based on the intra-prediction block, the inter-prediction block, or the final prediction block;
deriving the intra-prediction mode of the current block by using the gradient values; and
determining an inverse transform kernel of the secondary transform or an inverse transform kernel of a non-separable primary transform based on the derived intra-prediction mode.

16. A method of encoding a current block by a video encoding apparatus, the method comprising:
determining a motion vector of the current block;
generating an inter-prediction block of the current block based on the motion vector;
deriving an intra-prediction mode of the current block;
determining whether the current block is to be subblock-partitioned and a partition shape based on a size of the current block and the intra-prediction mode;
generating an intra-prediction block of the current block based on the whether the current block is to be subblock-partitioned, and the intra-prediction mode;
determining weights for the inter-prediction block and the intra-prediction block based on one or more of a number of blocks decoded according to intra prediction among neighboring blocks of the current block, a number of blocks decoded according to inter prediction among the neighboring blocks, the intra-prediction mode, the size of the current block, and the whether the current block is to be subblock-partitioned; and
generating a final prediction block of the current block by weighted summing the inter-prediction block and the intra-prediction block based on the weights.

17. The method of claim 16, further comprising:
determining, based on the inter-prediction block and the final prediction block, a combined inter and intra prediction flag (CIIP flag) that indicates whether a CIIP mode is to be used; and
encoding the CIIP flag.

18. The method of claim 17, further comprising:
checking the CIIP flag,
wherein the method further comprises, when the CIIP flag is true:
generating residual signals by subtracting the final prediction block from an original block of the current block;
determining transform kernels for a primary transform and/or a secondary transform of the current block; and
generating transform coefficients of the current block by transforming the residual signals by using the transform kernels.

19. The method of claim 18, wherein determining the transform kernels comprises:
calculating gradient values based on the final prediction block;
deriving the intra-prediction mode of the current block by using the gradient values; and
determining the transform kernels based on the derived intra-prediction mode.

20. A computer-readable recording medium storing a bitstream generated by a video encoding method, wherein the video encoding method comprises:
determining a motion vector of a current block;
generating an inter-prediction block of the current block based on the motion vector;
deriving an intra-prediction mode of the current block;
determining whether the current block is to be subblock-partitioned and a partition shape based on a size of the current block and the intra-prediction mode;
generating an intra-prediction block of the current block based on the whether the current block is to be subblock-partitioned, and the intra-prediction mode;
determining weights for the inter-prediction block and the intra-prediction block based on one or more of a number of blocks decoded according to intra prediction among neighboring blocks of the current block, a number of blocks decoded according to inter prediction among the neighboring blocks, the intra-prediction mode, the size of the current block, and the whether the current block is to be subblock-partitioned; and
generating a final prediction block of the current block by weighted summing the inter-prediction block and the intra-prediction block based on the weights.
